(19) United States
(12) Patent Application Publication
(10) Pub. No.: US 2014/0166044 A1
(43) Pub. Date: Jun. 19, 2014

(54) Method of removal of snow or ice coverage from solar collectors

(71) Applicants: Zvika Klier, Tel Aviv (IL); Roy Efron, Ramat Gan (IL); Michael Adel, Zichron Ya'akov (IL); Shimon Klier, Savyon (IL)

(72) Inventors: Zvika Klier, Tel Aviv (IL); Roy Efron, Ramat Gan (IL); Michael Adel, Zichron Ya'akov (IL); Shimon Klier, Savyon (IL)

(73) Assignee: TIGI LTD., Neve Yarak (IL)

(21) Appl. No.: 13/698,052

(22) PCT Filed: May 12, 2011
(86) PCT No.: PCT/IB11/52098

§ 371 Date: Feb. 24, 2014

Related U.S. Application Data
(60) Provisional application No. 61/334,595, filed on May 14, 2010.

(51) Int. Cl. F24J 2/46; E01H 5/10; B08B 7/02

(52) U.S. Cl. CPC F24J 2/461; B08B 7/02; E01H 5/10
USPC 134/1; 15/94; 126/271.1

(57) ABSTRACT

A system and method for prevention and removal of snowpack from solar panels increases the collection efficiency of solar panels by using one or more techniques, alone or in combination including: vibrating a vibrationally isolated surface of the solar panel; flexing a flexible sheet attached to the solar panel; inducing vibrations via extenial circulation piping for detaching the snowpack from at least one solar thermal collector of a solar array; activating a heat-pipe to transfer heat from an absorber plate to the surface of the collection panel; and using a PZT to generate vibrations for detaching the snowpack from the solar panel.

### CROSS-REFERENCE TO RELATED APPLICATIONS

This application claims the benefit of provisional patent application (PPA) Ser. No. 61/334,595 filed May 14, 2010 by the present inventors, which is incorporated by reference.

### FIELD OF THE INVENTION

The present embodiment generally relates to solar panels, and in particular, it concerns removing snow and ice from solar collectors.

### BACKGROUND OF THE INVENTION

Solar collection panels convert solar radiation to energy for a variety of applications within residential or industrial structures. Solar collection panels are simply referred to as solar panels, and are also known as solar energy collectors or solar modules. Typical applications include photovoltaic conversion, such as electricity generation, and thermal conversion, such as water heating, space heating, and industrial process heating. Solar panels used for thermal conversion are also referred to as solar thermal units or solar thermal collectors. A variety of solar panels are commercially available, and deployment, operation, and maintenance of conventional solar panels is well known in the industry.

Referring to FIG. 3, a simplified diagram of a solar panel 300, solar radiation (shown as LIGHT) is collected by a collection panel 302 for conversion and eventual use by applications 304. During periods of cold temperatures, in particular during winter months, snow and ice can buildup on the collection panel. Conventional solar panels have relatively low efficiency in the winter months due to heat losses from the collection panels of solar thermal units and reduced exposure to solar radiation for photovoltaic conversion. As a result, prevention and removal of snow and ice buildup from solar panels has not been a high priority in the industry.

The invention of insulated solar panels provides a solar thermal collector with much greater energy conversion efficiencies, as compared to conventional solar thermal collectors. An insulated solar panel is a solar thermal collector with transparent insulation material for the collection panel. In this case “insulated” refers to the transparent insulation material behind the surface of the collection panel—inside the solar panel, between the low-E glass and absorber, as opposed to the conventional insulation typically used in the back and sides of a solar thermal collector. Insulated solar panels are available from TIGI of Neve Yarak, Israel. Thermally insulating panels transmissive to solar radiation, while having low transmissivity to thermal infra-red radiation, have been disclosed in U.S. Pat. No. 4,480,632, U.S. Pat. No. 4,719,902, U.S. Pat. No. 4,815,442, U.S. Pat. No. 4,928,665, and U.S. Pat. No. 5,167,217 all to Klier and Novik. Greater energy conversion efficiencies occur particularly under conditions of substantial temperature differentials between the ambient temperature and the temperature of the circulating fluid (for example, heated water) inside the collector, for example in cold, high latitudes in winter.

There is therefore a need for a system and method for removal of snow and ice from solar collectors.

### SUMMARY

According to the teachings of the present embodiment there is provided a system for removing snowpack from a solar panel, the system including: a substantially vibrationally isolated surface of the solar panel; and a vibration generator operationally connected to the substantially vibrationally isolated surface; wherein the vibration generator generates vibrations for detaching the snowpack from the substantially vibrationally isolated surface.

In an optional embodiment, the substantially vibrationally isolated surface is a low-emission (low-E) glass surface of a collection panel. In another optional embodiment, the substantially vibrationally isolated surface is a transparent cover over the surface of the collection panel. In another optional embodiment, the vibration generator generates vibrations in frequency bands which are close to, or overlap with, one or more resonant frequencies of the substantially vibrationally isolated surface and the frequency bands are distinct from resonant frequencies of other components of the solar panel, thereby substantially vibrationally isolating the substantially vibrationally isolated surface from the other components of the solar panel. In another optional embodiment, the system further includes a control system and at least one sensor, wherein the control system is configured to activate the vibration generator based on information from the at least one sensor.

According to the teachings of the present embodiment there is provided a system for removing snowpack from a solar panel, the system including: a flexible sheet attached to the solar panel, wherein the flexible sheet is configured to flex for detaching the snowpack from the flexible sheet. In an optional embodiment, the flexible sheet is flexible glass.

According to the teachings of the present embodiment there is provided a system for removing snowpack from a solar thermal collector array, the solar thermal collector array including external circulation piping connected to at least one solar thermal collector, the system including: vibration generator operationally connected to the external circulation piping; wherein the vibration generator induces via the external circulation piping vibrations for detaching the snowpack from at least one solar thermal collector. In an optional embodiment, the vibration generator induces vibrations by vibrating the external circulation piping. In another optional embodiment, the vibration generator induces vibrations by injecting pressure waves into a circulation fluid in the external circulation piping. In another optional embodiment, the vibration generator includes an acoustic transducer. In another optional embodiment, the vibration generator injects pressure waves tuned to a resonant frequency of a collection panel surface of the solar thermal collector.

According to the teachings of the present embodiment there is provided a system for removing snowpack from a solar panel, the solar panel including a surface having the snowpack attached and the solar panel including an absorber, the system including: a control system; and a heat pipe including: a first section in thermal contact with the absorber; a second section in thermal contact with the surface having the snowpack attached, wherein the control system activates the heat pipe to enable transfer of sufficient heat from the absorber to the surface for at least partially detaching the snowpack from the surface.

According to the teachings of the present embodiment there is provided a system for removing snowpack from a solar panel, the system including: a piezoelectric transducer (PZT) in contact with the solar panel, wherein the PZT is configured to generate vibrations for detaching the snowpack from the solar panel. In an optional embodiment, the PZT is inside the solar panel.

According to the teachings of the present embodiment there is provided a method for removing snowpack from a solar panel, the method including generating, via a vibration generator, vibrations for detaching the snowpack from a substantially vibrationally isolated surface of the solar panel. In an optional embodiment, a control system is configured to activate the vibration generator based on information from at least one sensor. In another optional embodiment, the vibration generator is activated repeatedly. In another optional embodiment, the vibration generator is activated periodically. In another optional embodiment, generating vibrations is used in combination with a technique selected from the group consisting of: addition of an adhesion suppressive coating to; application of a heat pulse to; and tilting of the substantially vibrationally isolated surface of the solar panel.

According to the teachings of the present embodiment there is provided a method for removing snowpack from a solar panel, the method including: flexing a flexible sheet attached to the solar panel, the flexing for detaching the snowpack from the flexible sheet.

According to the teachings of the present embodiment there is provided a method for removing snowpack from a solar thermal collector array, the solar thermal collector array including external circulation piping connected to at least one solar thermal collector, the method including: inducing vibrations via the external circulation piping for detaching the snowpack from at least one solar thermal collector. In an optional embodiment, the vibrations are induced by vibrating the external circulation piping. In another optional embodiment, the vibrations are induced by injecting pressure waves into a circulation fluid in the external circulation piping. In another optional embodiment, the pressure waves are injected by an acoustic transducer. In another optional embodiment, the pressure waves are injected at a frequency sufficient for inducing vibrations at a resonant frequency of a collection panel surface of the solar thermal collector.

### BRIEF DESCRIPTION OF FIGURES

The embodiment is herein described, by way of example only, with reference to the accompanying drawings, wherein:

FIG. 1 is a diagram of a cross-section view of a sealed insulated solar panel.

FIG. 2 is a diagram of a heating element attached to the surface of a collection panel.

FIG. 3 is a simplified diagram of a solar panel.

FIG. 4A is a diagram of a solar panel with snowpack.

FIG. 4B is a diagram of a collection panel reconfigured for removal of snowpack.

FIG. 4C is a diagram of a solar panel after snowpack has detached.

FIG. 5 is an example diagram of a solar array.

FIG. 6 is a diagram of actively using a heat pipe to remove snowpack from a solar panel.

### DETAILED DESCRIPTION

The principles and operation of the system according to a present embodiment may be better understood with reference to the drawings and the accompanying description. A present embodiment is a system and method for prevention and removal of snowpack from solar panels. In the context of this document, the term snowpack refers to the total snow and ice on a surface (refer to The National Snow and Ice Data Center (NSIDC) glossary) and/or all forms and combinations of frozen water that are deposited onto a solar panel including, but not limited to, snow, ice, slush, ice-covered snow, snow-covered ice, and related combinations.

The system facilitates active prevention of snowpack buildup and removal of snowpack from the collection panel of a solar panel. The system increases the collection efficiency of solar panels by using one or more methods, alone or in combination, to prevent and remove snowpack buildup from solar collectors. In one implementation, a surface of the collection panel is substantially vibrationally isolated from the other components of the solar panel. A vibration generator is operationally connected to the substantially vibrationally isolated surface. The vibration generator generates vibrations for detaching the snowpack from the substantially vibrationally isolated surface, either alone, or in combination with other described techniques.

For clarity, the current description uses the preferred implementation of an insulated thermal panel with snowpack, however, embodiments of the current invention are not limited to this implementation. Additional and alternative implementations include, but are not limited to removal of icepack from conventional solar collection panels, including both thermal conversion modules and photovoltaic conversion modules and removal of deposits and condensation of other materials in both residential and industrial applications.

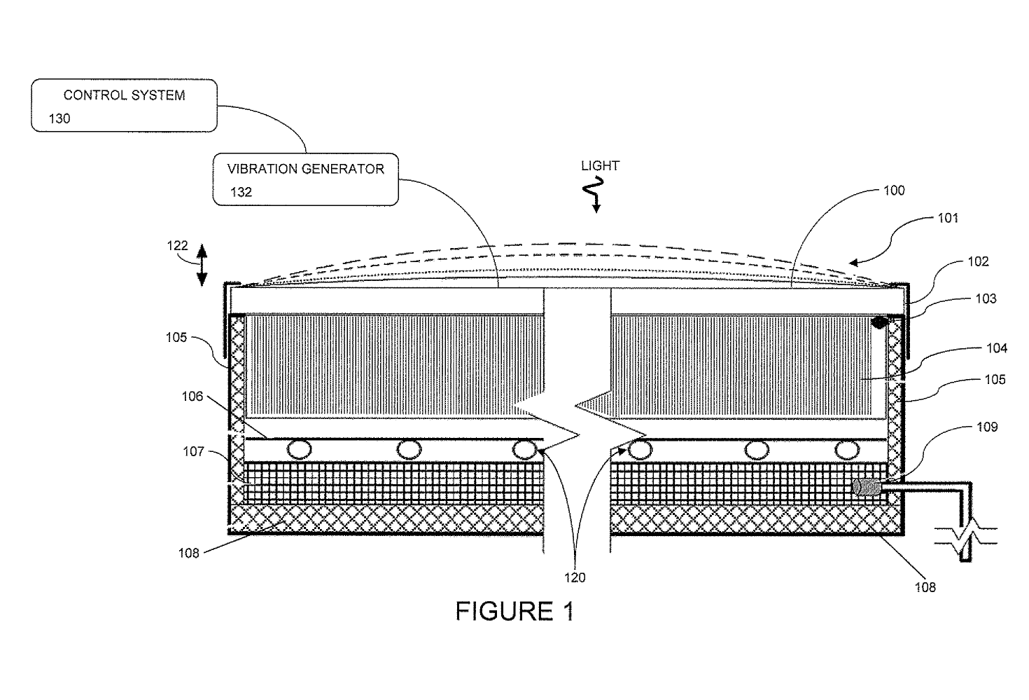

Referring now to the drawings, FIG. 1 is a diagram of a cross-section view of a sealed insulated solar panel. Low emissivity (low-E) glass 100 is held by a frame 102 allowing LIGHT (as near IR and visible wavelength light are typically referred to in this context) through transparent insulation 104 to reach absorber 106. Absorber 106 is also known as an absorber plate. A surface, or face, of the low-E glass that is positioned toward the source of solar radiation is also known as the surface of the collection panel. Circulation pipes 120 (end-view as shown by circles below/behind absorber 106) circulate a transfer fluid to absorb heat from the absorber 106 and transfer the heat to applications. Note that connections between circulation pipes 120 and applications are not shown. Note also that for clarity a single solar panel is shown. Typically, multiple solar panels are used with serial and/or parallel connections between solar panels within a solar array. In a case like this connections to and from circulation pipes of a single solar panel can be from or to (respectively) applications or one or more solar panels. Configuration and connection between solar panels and applications will be obvious to one skilled in the art. Melamine insulation 107 provides an internal insulator between the back of the absorber 106 plate and the backside of the solar panel. Lateral insulation 105 and rear thermal insulation 108 provide a thermal barrier on sides and back, respectively.

Conventional methods of reducing the buildup of snow and ice include the addition of an adhesion suppressive coating to the outer surface of a solar panel, in particular the face of the collection panel. Examples of adhesion suppressive coatings for repelling water and snow are described in European patent number EP00754738A1 assigned to NTT, and U.S. Pat. No. 6,949,278 assigned to 3M. Historically, these coatings have been applied to the problem of various building structures and surfaces, but not solar panels. As described above, conventional solar panels have relatively low efficiency in the winter months, so, prevention and removal of snow and ice buildup from solar panels has not been a high priority in the industry. Furthermore, methods such as application of adhesion suppressive coatings alone do not eliminate the problem of snowpack. With heavy enough snowdrifts, buildup of snowpack on solar collector panels cannot be avoided by adhesion suppressive coatings, and additional methods are necessary to prevent buildup and remove snowpack. In a preferred implementation, conventional adhesion suppressive coatings are used in combination with the innovative methods described below.

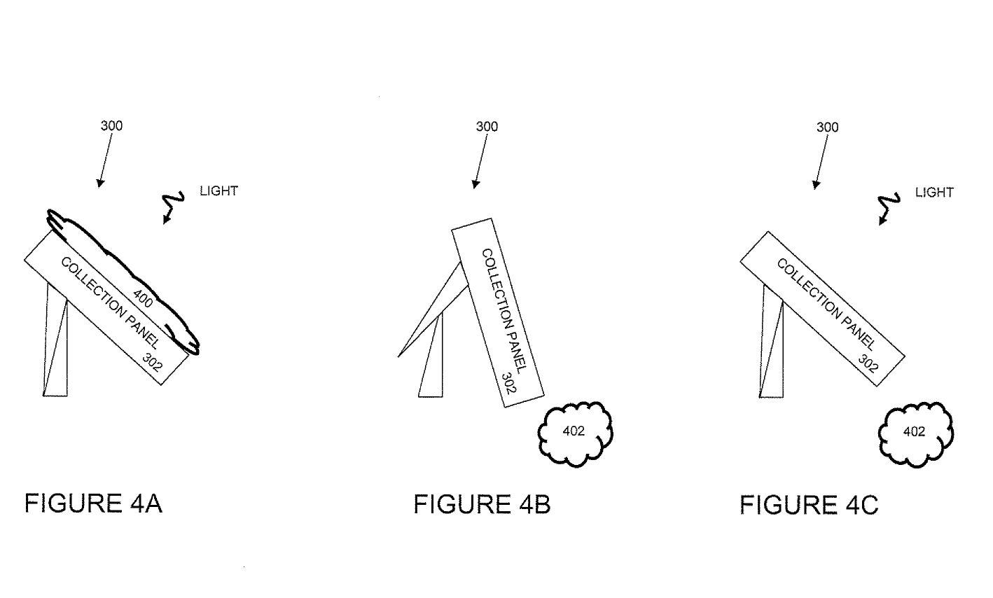

Referring to FIG. 4A, a diagram of a solar panel with snowpack 400, the snowpack prevents LIGHT from reaching the collection panel 302. To help remove the snowpack from the collection panel, the collection panel is physically reconfigured from an angle of normal operation to an angle sufficient for the snowpack to detach from the collection panel. In other words, the collection panel is tilted enough so the snowpack falls off, or does not accumulate in the first place. Referring to FIG. 4B, a diagram of a collection panel reconfigured for removal of snowpack, the collection panel has been mechanically raised from a normal angle of operation, and snowpack 400 has detached from the solar panel. The detached snowpack 402 is shown below the collection panel 302. The angle of the collection panel can be increased temporarily or intermittently, one or more times as necessary. The increased angle in combination with gravity facilitates the snowpack detaching from the surface of the collection panel and sliding down the face of the collection panel. A sufficiently large area should be provided below the solar panel for an anticipated volume of snowpack removal. Good engineering and design should preferably include safety considerations for the area around the solar panel (solar panel array), in particular care should be taken that detached snowpack does not fall in pedestrian areas. In FIG. 4C, a diagram of a solar panel after snowpack has detached, the collection panel 302 has returned to a normal angle of operation, snowpack 402 is not obstructing the face of the collection and panel, and LIGHT can reach the collection panel. Reconfiguration of the angle of the collection panel is preferably used in combination with techniques for reducing the coefficient of friction between the surface (face) of the collection panel and the snowpack, such as addition of an adhesion suppressive coating to the surface of the collection panel. Techniques for moving and/or reconfiguring the angle of system components are known in the art, and based on the current description, one ordinarily skilled in the art will be able to select and implement an appropriate technique for a specific implementation of the present embodiment.

Referring again to FIG. 1, innovative mechanical techniques that include the use of vibration are now described to prevent buildup and facilitate removal of snowpack from a solar panel. Activation of vibration of a solar panel or one or more components of the solar panel can be sufficient to vibrate the surface of the collection panel and detach a snowpack from the collection panel. This shaking of the solar panel and/or collection panel in combination with gravity facilitates the snowpack detaching from the surface of the collection panel and sliding down the face of the collector.

A system for removing snowpack from a solar panel includes a vibrationally isolated surface of the solar panel having the snowpack attached. The conventional collection panel surface of low-E glass 100 is replaced with a surface that is substantially vibrationally isolated from the other components of the solar panel. In the context of this description, the term substantially vibrationally isolated generally refers to sufficiently isolating a first component from other components such that when the first component is vibrated for a given task the other components are vibrated less than a pre-determined threshold. This pre-determined threshold would typically be chosen to avoid and reduce long-term damage to the other components. The type and amount of vibrational isolation depends on the specifics of the system. In a non-limiting example, the surface of the collection panel is heated prior to vibration. The heating loosens the snowpack and a lesser degree of vibration is required, as compared to a system using only vibration. In this case, the vibrational isolation required is less than in a system using only vibration to remove snowpack.

In addition to mechanical methods of vibration isolation, which are know in the art, an alternative method of achieving substantial vibration isolation is by selection of vibration frequency bands which are close to, or overlap with, one or more of the resonant frequencies of the surface of the collection panel, but potentially distinct from the resonant frequencies of the other components of the solar panel.

A control system 130 is operationally connected to a vibration generator 132. The implementation of the vibration generator is dependent on the specific requirements and use of the system. Implementations of the vibration generator include, but are not limited to,

creation of vibrations which are then transferred to the component to be vibrated, and

signaling a component to activate a vibration mode.

The vibration generator is configured for activation by the control system. The vibration generator is operationally connected to the vibrationally isolated surface. The control system activates the vibration generator to generate vibrations for detaching snowpack from the vibrationally isolated surface. Optionally, the vibration generator can be operated directly, independent of a control system. In a non-limiting example, a user can manually activate and deactivate the vibration generator.

An implementation of a system for vibrating the surface of a collection panel includes replacing a conventional collection panel surface of low emissivity (low-E) glass 100 with a flexible sheet 101, such as a sheet of flexible low-E glass. In FIG. 1, the flexing of sheet 101 is represented (not to scale) by several dashed arcs above the surface of the collection panel. Arrow 122 shows typical directions of movement for flexing the flexible sheet 101. The flexible sheet allows flexing of the surface of the collector panel, in combination or preferably independent of the movement of other components of the solar panel. The control system activates the vibration generator, which actuates the flexible sheet to flex sufficiently to at least partially detach the snowpack from the vibrationally isolated surface

Flexing and vibrating the surface of the collector panel can each be done independently or in combination with each other and/or in combination with other techniques described in this document. Both flexing and vibrating the surface of the collector panel are done one or more times, sufficient for the snowpack to detach from the collection panel.

Another option for vibrating and/or flexing a surface for removal of snowpack includes adding a transparent cover over the surface of the collection panel (not shown in FIG. 1). In this case, snowpack accumulates on the surface of the transparent cover, as opposed to accumulating directly on the surface of the collection panel. The transparent cover can be vibrated or flexed independent of the solar panel, thereby detaching snowpack from the surface of the transparent cover, allowing solar radiation to be collected by the collection panel, and eliminating or reducing movement of the components of the solar panel.

As opposed to conventional solutions that vibrate an entire solar panel, moving only the surface of the collection panel eliminates, or reduces, movement of other components of the solar panel. Typically, reduced movement of components increases the life span and reduces the mean time to failure of the components.

Another implementation for vibration of a solar panel includes using an embedded vibration transducer 109. Activation of the vibration transducer vibrates the solar panel, and hence vibrates the surface of the collection panel. The embedded vibration transducer can be implemented as an additional dedicated transducer, such as an electromechanical transducer. A preferred implementation is to use a piezoelectric transducer (PZT, lead zirconate titanate) to vibrate the solar panel. The location of embedded vibration transducer 109 is shown in FIG. 1 as a non-limiting example. Based on this description, one skilled in the art will be able to select a location and select a transducer type suitable for a specific implementation in a solar panel.

In a case where the vibration transducer is in contact with the surface of the collection panel, the collection panel can be vibrationally isolated from the other components of the solar panel, facilitating vibration of the collection panel independent of the other components of the solar panel.

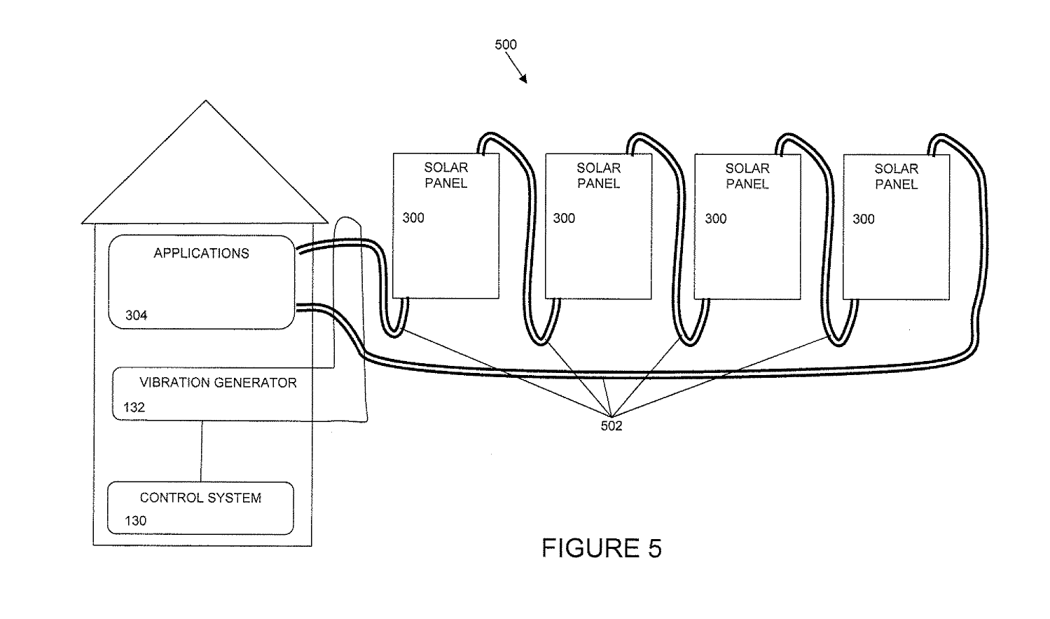

Referring to FIG. 5, an example diagram of a solar array 500, two or more of solar panel 300 are used in a solar array. External circulation pipes 502, also known as heat transfer pipes, transfer a circulating fluid from one or more solar panels in the array to one or more other solar panels in the solar array and/or to one or more applications 304. In this case, applications 304 are thermal applications.

An innovative solution for vibrating a thermal solar panel, without requiring addition of components to the solar panel, includes using induced vibrations in existing external circulation pipes 502 to induce vibrations in one or more solar panels 300. Inducing vibrations in an external circulation pipe attached to a solar panel induces vibrations in the attached solar panel.

Because all of the solar panels in a solar array are coupled via the external circulation pipes, vibrations induced in the circulation pipes can be simultaneously transferred to multiple solar panels. Construction and connection of the external circulation pipes to, and between, the solar panels in the solar array will help determine if how, and how much of the induced vibration in the circulation pipes is transferred to the solar panels. Construction and connection can include serial, parallel, and a combination of connection topologies.

A system for removing snowpack from a solar panel array includes external circulation piping 502 connected to at least one solar panel 300 in the solar panel array. A control system 130 is operationally connected to a vibration generator 132. The vibration generator is configured for activation by the control system and operationally connected to the external circulation piping 502. The control system activates the vibration generator to generate vibrations in the external circulation piping to vibrate at least one solar panel for at least partially detaching the snowpack from at least one solar panel.

In the context of this document, the term inducing vibrations in external circulation piping includes, but is not limited to, vibrating the pipes that carry a circulation fluid and inducing pressure waves in the circulation fluid inside the pipes. Vibrating the pipes can be done using a vibration generator connected to the existing external circulation piping 502. The location where the vibration generator is connected and the method of connection can vary depending on the specific architecture of the system and goals for snowpack removal. One option is for a single vibration generator to be connected to either the inlet or outlet (supply or return) pipes. Another option is for a single vibration generator to be connected to at least one supply and at least one return pipe. Another option is to use two vibration generators, one connected to the supply pipe(s) and one connected to the return pipe(s). Another option is to connect at least one vibration generator to the piping between solar panels. In some systems, preference may be to use a single vibration generator at the back-end, while in other systems preference may be to use multiple vibration generators closer to the front-end. Based on this description, one skilled in the art will be able to select one or more locations and method of connection of one or more vibration systems, appropriate for the system.

Mechanical vibration of the external circulation pipes can be achieved by an injection of pressure waves in the circulation fluid. Preferably, pressure waves can be injected by components added to the system away from the solar array 500, in the area of the applications 304. Pressure wave and/or vibration inducing components can also be added to the system at the area of the solar array. Generally, components added in the “back-end” area of the system, which is the area of the applications, are easier to access and maintain. Adding components at the “front-end”, which is the area of the solar panels, is generally avoided, as the area of the solar array is often less accessible than the back-end area.

A preferable technique for inducing pressure waves is to use an acoustic transducer embedded in an external circulation pipe. The acoustic transducer can be embedded within the solar panel or preferably at a remote location. If the frequency of the pressure modulation from the acoustic transducer is tuned to the resonant frequency of the overall dimensions of the solar panel, the vibration is enhanced while also requiring less energy to generate sufficient vibration, as compared to using a non-tuned frequency of pressure modulation. Using a tuned frequency of pressure modulation also lessens the detrimental effects of the induced vibrations on the smaller components of the system (smaller as compared to the overall dimensions of the solar panel). In the context of this document, resonant frequency includes the frequency that creates the largest amplitude vibration of the component to be vibrated, per unit power of vibration induced.

Induced vibrations in existing external circulation pipes can be implemented without requiring additional or dedicated components at the solar panel (solar panel array). As will be obvious to one skilled in the art, the circulation pipes and support structure for the solar array should be designed to handle vibration sufficient for the snowpacks to detach from the collection panels of the solar panels in the array. Note that depending on the application, removal of snowpack may not be required for all solar panels. Enough solar panels must be sufficiently clear to provide the desired output for the application.

Now described are innovative thermal techniques to prevent buildup and facilitate removal of snowpack from a solar panel. In general, heat is applied one or more times to the surface of the collection panel using one or more thermal techniques, optionally in combination with mechanical and conventional techniques. In the context of this document, this application of heat is referred to as a heat pulse. The heat pulse can partially melt the snowpack in immediate contact with the surface of the collection panel, causing a reduction in the adhesion of the snowpack to the surface, allowing the snowpack to detach and slide down the surface of the collection panel.

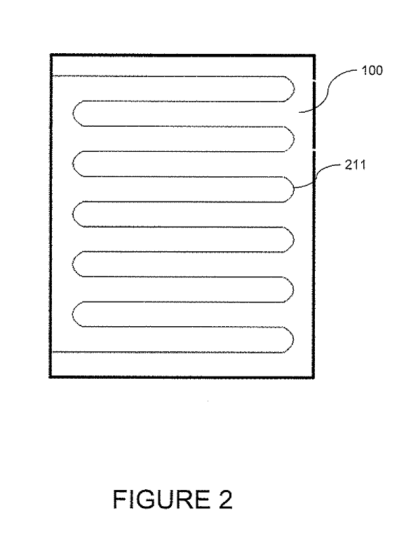

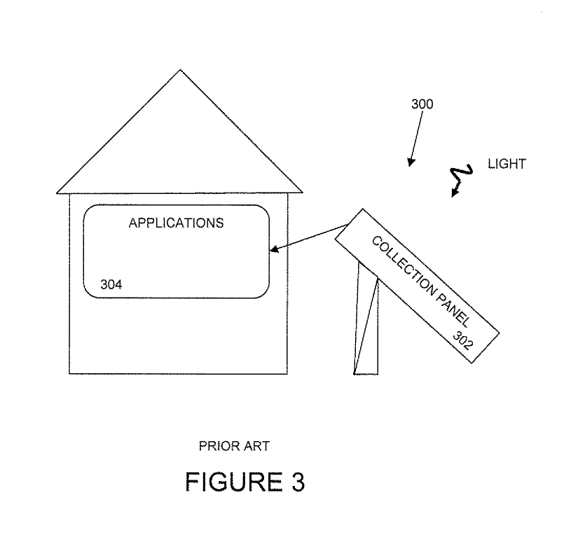

Referring to FIG. 2, a diagram of a heating element attached to the surface of a collection panel, heating wire 211 is attached to low-E glass 100. Heating elements are known in the art and a non-limiting example is a resistance wire embedded in the low-E glass. Alternatively, one or more heating elements can be coated on the outside or inside of the surface of the collection panel when a current is passed through the resistance wire, the wire generates heat that is transferred to the surface of the collection panel. The heated surface of the collection panel in combination with gravity facilitates the snowpack detaching from the surface of the collection panel and sliding down the face of the collection panel.

Techniques for delivering a heat pulse to a solar thermal unit include reversing the normal mode of operation to transfer heat from the circulation pipes to the surface of the collection panel. Under normal operation, solar radiation is collected by the absorber (FIG. 1, 106) and transferred as heat to the internal circulation pipes 120 (or more precisely the circulating fluid inside the internal circulation pipes), where the heat is then carried by the external circulation pipes (FIG. 5, 502) to applications 304. During cold weather conditions, adjusting the speed at which the circulating fluid flows can facilitate transferring heat in the circulating fluid from the relatively warmer circulation pipes to the relatively colder absorber. Reversing the flow of the circulating fluid can be used to draw heat from a heat reservoir associated with the applications, and transfer the drawn heat to the solar panel where the drawn heat is transferred to the absorber. A non-limiting example of reversing the flow of the circulation fluid, or simply reverse heat flow, is where a 3-phase pump is used to circulate the fluid. Reversing the polarity of the electricity supplied to the pump reverses the direction in which the pump circulates fluid. Heat that has been transferred from the circulation pipes to the absorber is then transferred to the relatively colder surface of the collection panel, delivering a heat pulse to the snowpack-covered surface.

An innovative technique for delivering a heat pulse to a solar thermal unit includes using an abrupt transition from insulation to conduction of one of the insulating components, such that heat from the circulation pipes is transferred to the surface of the collection panel. Examples of the methods that can be used to induce a transition from insulation to conduction are described in U.S. provisional patent application No. 61/295,789 to Klier et al, entitled “System and method for temperature limiting in a sealed solar energy collector” which is fully incorporated by reference,

A non-limiting example of using a transition from insulation to conduction is the use of a heat pipe to transfer heat from the internal circulation pipes to the surface of the collection panel. Under normal operation of the solar panel, the heat pipe is not active, being in an insulated state. In contrast to normal passive operation of a heat pipe, in the present embodiment the heat pipe is actively signaled to abruptly transition from a state of insulation to a state of conduction. In the conductive state, the heat pipe transfers heat from internal solar panel components, such as internal circulation pipes and absorber, to the surface of the collection panel. Activation of the heat pipe includes transitioning the heat pipe from a state where the heat pipe is thermally isolated to a state where the heat pipe is thermally conductive. Activation of the heat pipe can be by a number of triggers, as is described below in reference to sensors and activation methods.

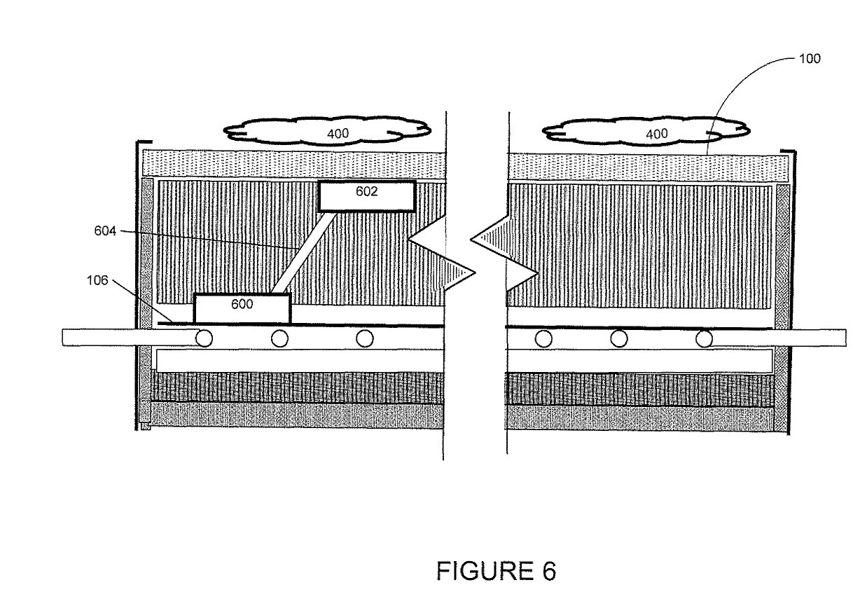

Referring to FIG. 6, a diagram of actively using a heat pipe to remove snowpack from a solar panel, a surface of a collection panel, in this case low-E glass 100, has snowpack 400 attached. A heat pipe includes a first section 600 in thermal contact with an absorber 106 and a second section 602 in thermal contact with the surface 100 having the snowpack attached. A transfer pipe 604 allows heat to be transferred between the first section and the second section. A control system (not shown) activates the heat pipe to enable transfer of sufficient heat from the absorber to the surface. Heat transferred to the surface warms the surface sufficiently to at least partially detach the snowpack from the surface. Heat may be present in the absorber, or heat can be transferred from the circulation pipes to the absorber. In an optional implementation, the first section 600 is in contact with the circulation pipes.

A technique for preventing snowpack buildup on an insulated solar panel includes designing and constructing areas of the surface of the collection panel without associated transparent thermal insulation. This thermal technique allows the areas without transparent thermal insulation to transfer heat from components on the inside of the insulated solar panel, such as the absorber, to the surface of the collection panel. As the outside temperature drops, heat is transferred to the surface of the collection panel in areas without transparent thermal insulation, and by conduction that heat is then transferred to other areas of the surface of the collection panel, thereby keeping the surface of the collection panel warm and preventing snowpack buildup. The current technique can optionally be used in combination with the reverse heat flow technique described above, to transfer heat from the system to the surface of the collection panel. During periods when the outside temperature is less than the inside temperature, the transferred heat acts as a heat pulse, warming the surface of the collection panel.

Another technique for preventing snowpack buildup includes the integration of absorption strips on the outside of the solar panel. Absorption strips can be implemented as actual strips of material, painted onto the solar panel, or deposited using any other relevant technique for applying a coating to a material. A preferred implementation is to coat a portion of the frame 102 of the collection panel casing with an absorption strip. One implementation of an absorption strip is to use a black spectrally selective coating. The spectrally selective coating increases absorption of solar radiation in the solar spectral domain and decreases re-emission in the infrared domain to reduce radiative heat losses. Thus, the absorption strip gets hotter than the other portions of the surface of the collection panel, such as the low-E glass. The absorption strip is thermally coupled to the surface of the collection panel, thereby allowing heat to transfer from the absorption strip to the surface of the collection panel and prevent snowpack buildup. Optionally, the outer casing or other component of the solar panel to which the absorption strip is attached can be thermally coupled permanently, temporarily, or intermittently to the collector surface.

As described above, conventional passive methods for reducing the buildup of snow and ice, such as adhesion suppressive coatings, are not sufficient to prevent and remove snowpack from insulated thermal panels. A feature of the current embodiment is active initiation of one or more techniques for prevention and removal of snowpack from a solar panel, and in particular from the surface of a collection panel. Active initiation, or activation, of one or more mechanical or thermal techniques, can be automated or user initiated. Activation can be based on information from one or more sensors, including, but not limited to:

changes in temperature in the area of the solar panel,

changes in temperature of the solar panel and/or collection panel,

changes in weight of the solar panel,

snowpack buildup, and

detection of snowpack on the solar panel.

Conventional techniques for determining if a collection panel is obstructed fail to provide sufficiently accurate information on the existence and quantity of snowpack on a collection panel. Examples of conventional techniques are taught in U.S. patent application Ser. No. 12/770,278 to Kaiser et al for Solar Power Systems Optimized For Use In Cold Weather Conditions. One example of a conventional technique is measuring the output of a PV panel, and using a reduced electrical output of the PV panel as an indicator of snow on the collection panel. As reduced electrical output can be caused by conditions other than snow on the collection panel, for example reduced solar radiation due to cloud cover, innovative solutions are required to provide accurate information on the existence and quantity of snowpack.

Referring again to FIG. 1, an innovative solution for detecting the existence and quantity of snowpack on a collection panel includes the use of an optical snow sensor 103. The snow sensor can be placed inside a sealed insulated solar panel and detect the existence and quantity of snowpack on the surface of the collection panel. A snow sensor can provide direct detection of snowpack with increased accuracy, in comparison to conventional techniques that provide indirect detection. Snow sensors are known in the art and based on this description, on ordinarily skilled in the art will be able to select an appropriate snow sensor for a specific implementation of the present embodiment. One option for a snow sensor is SNO-0110 Optical Snowmelt Sensor by HEX Control Systems, Calgary, Canada. Another option for a snow sensor is to integrate into a solar panel an LED light source co-located with a photodiode. Preferably, the LED and photodiode are internal to the solar panel, behind the low-E glass, and positioned facing outward toward the surface of the collection panel. The LED and photodiode are configured such that the presence of snowpack increases the back reflected signal, the change of which is detected and used to trigger activation of snowpack removal. Another sensor option is a weight sensor that is triggered by the continuous pressure resulting from snowpack on the solar panel.

Preferred implementations include the use of multiple sensors in the system for detection of snowpack on the solar panel. Non-limiting examples of additional and alternative sensors include, but are not limited to, temperature and weight sensors at the collection panel. Information from external sources such as weather reporting and weather forecasting stations can be used in combination with sensors in the system. In a case where local weather data is available and sufficiently accurate for the area of the solar panel, implementations are possible using the local weather data without the expense of additional system sensors at the collection panel. Weather forecasts can be used to prepare the system for snowpack removal in anticipation of weather conditions for snowpack buildup. System preparations include, but are not limited to storing extra heat for later use, pre-configuring the angle of the collection panel to avoid snowpack buildup, and pre-heating the surface of the collection panel to prevent snowpack buildup.

Activation of techniques for snowpack prevention and buildup can also be user initiated. A simple non-limiting example is a user coming to work in the morning and seeing that snowpack has accumulated on the collection panels of the solar array at work. The user then activates one or more techniques for snowpack removal, allowing solar radiation conversion for use of energy from the solar array during the workday. Based on sensor feedback and/or observation of the solar array during the day, one or more techniques can be activated or deactivated as appropriate during the workday.

A desirable feature of system operation is to minimize the application of thermal or mechanical energy to the solar panel to improve overall system efficiency and reduce the risk of unintended long-term damage to the solar panel. In a preferred implementation, a control system uses sensor information and/or user input to activate and de-activate the above-described techniques for prevention and removal of snowpack from a solar panel.

In general, prevention and removal of snowpack from a solar panel can be facilitated by any combination or permutation of the above-described techniques. Techniques can be applied simultaneously or in a specific sequence continuously, repeatedly, and/or periodically. A non-limiting example of a possible sequence for snowpack removal includes in a first step a thermal pulse delivered to the collector surface in order to melt a thin layer of snowpack adjacent to the surface of the collection panel and detach the snowpack from the surface of the collection panel. In a second step, the solar panel is vibrated to shake the detached snowpack, causing the snowpack to slide off the collector. In general, the addition of adhesion suppressive coatings on the surface of the collection panel if preferred to enhance the efficiency of the removal technique.

In order to minimize wiring requirements, the system can use wireless and/or cellular communications for communications between the area of the solar panel and a control system. The system can be augmented with a self-contained photovoltaic collector panel and rechargeable battery as an electricity source at the area of the solar panel. This electricity source can be used to power sensors and communication devices at the area of the solar panel. In addition, to the controls and sensors and communication devices specified above.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

It should be noted that the above-described examples, numbers used, and exemplary calculations are to assist in the description of this embodiment. Inadvertent typographical and mathematical errors should not detract from the utility and basic advantages of the invention.

It will be appreciated that the above descriptions are intended only to serve as examples, and that many other embodiments are possible within the scope of the present invention as defined in the appended claims.

What is claimed is:

1. A system for removing snowpack from a solar panel, the system comprising:
(a) a substantially vibrationally isolated surface of the solar panel; and
(b) a vibration generator operationally connected to said substantially vibrationally isolated surface;
wherein said vibration generator is configured for generating vibrations for detaching the snowpack from said substantially vibrationally isolated surface.

2. The system of claim 1 wherein said substantially vibrationally isolated surface is a low-emission (low-E) glass surface of a collection panel.

3. The system of claim 1 wherein said substantially vibrationally isolated surface is a transparent cover over the surface of the collection panel.

4. The system of claim 1 wherein said vibration generator generates vibrations in frequency bands which are close to, or overlap with, one or more resonant frequencies of said substantially vibrationally isolated surface and said frequency bands are distinct from resonant frequencies of other components of the solar panel, thereby substantially vibrationally isolating said substantially vibrationally isolated surface from the other components of the solar panel.

5. The system of claim 1 further including a control system and at least one sensor, wherein said control system is configured to activate said vibration generator based on information from said at least one sensor.

6. A system for removing snowpack from a solar panel, the system comprising:
(a) a flexible sheet attached to the solar panel,
wherein said flexible sheet is configured to flex for detaching the snowpack from said flexible sheet.

7. The system of claim 6 wherein said flexible sheet is flexible low-E glass.

8. A system for removing snowpack from a solar thermal collector array, the solar thermal collector array including external circulation piping connected to at least one solar thermal collector, the system comprising:
(a) a vibration generator operationally connected to said external circulation piping;
wherein said vibration generator is configured to induce, via said external circulation piping, vibrations for detaching the snowpack from at least one solar thermal collector.

9. The system of claim 8 wherein said vibration generator induces vibrations by vibrating said external circulation piping.

10. The system of claim 8 wherein said vibration generator induces vibrations by injecting pressure waves into a circulation fluid in said external circulation piping.

11. The system of claim 10 wherein said vibration generator includes an acoustic transducer.

12. The system of claim 10 wherein said vibration generator injects pressure waves tuned to a resonant frequency of a collection panel surface of the solar thermal collector.

13. A system for removing snowpack from a solar panel, the solar panel including a surface having the snowpack attached and the solar panel including an absorber, the system comprising:
(a) a control system; and
(b) a heat pipe including:
(i) a first section in thermal contact with the absorber;
(ii) a second section in thermal contact with the surface having the snowpack attached,
wherein said control system is configured for activating said heat pipe to enable transfer of sufficient heat from the absorber to the surface for at least partially detaching the snowpack from the surface.

14. A system for removing snowpack from a solar panel, the system comprising:
(a) a piezoelectric transducer (PZT) in contact with the solar panel,
wherein said PZT is configured to generate vibrations for detaching the snowpack from the solar panel.

15. The system of claim wherein said PZT is inside the solar panel.

16. A method for removing snowpack from a solar panel, the method comprising: generating, via a vibration generator, vibrations for detaching the snowpack from a substantially vibrationally isolated surface of the solar panel.

17. The method of claim 16 wherein a control system is configured to activate said vibration generator based on information from at least one sensor.

18. The method of claim 16 wherein said vibration generator is activated repeatedly.

19. The method of claim 16 wherein said vibration generator is activated periodically.

20. The method of claim 16 wherein generating vibrations is used in combination with a technique selected from the group consisting of:
(a) addition of an adhesion suppressive coating to;
(b) application of a heat pulse to; and
(c) tilting of;
said substantially vibrationally isolated surface of the solar panel.

21. A method for removing snowpack from a solar panel, the method comprising: flexing a flexible sheet attached to the solar panel, said flexing for detaching the snowpack from the flexible sheet.

22. A method for removing snowpack from a solar thermal collector array, the solar thermal collector array including external circulation piping connected to at least one solar thermal collector, the method comprising: inducing vibrations via said external circulation piping for detaching the snowpack from at least one solar thermal collector.

23. The method of claim 22 wherein vibrations are induced by vibrating said external circulation piping.

24. The method of claim 22 wherein vibrations are induced by injecting pressure waves into a circulation fluid in said external circulation piping.

25. The method of claim 24 wherein said pressure waves are injected by an acoustic transducer.

26. The method of claim 25 wherein pressure waves are injected at a frequency sufficient for inducing vibrations at a resonant frequency of a collection panel surface of the solar thermal collector.
